(19) United States
(12) Patent Application Publication
(10) Pub. No.: US 2023/0009964 A1
(43) Pub. Date: Jan. 12, 2023

(54) IMPROVED SCHEDULING FOR A ROBOTIC WORK TOOL

(71) Applicant: HUSQVARNA AB, Huskvarna (SE)

(72) Inventors: Herman Jonsson, HUSKVARNA (SE); Adam Saxén, JÖNKÖPING (SE)

(21) Appl. No.: 17/784,871

(22) PCT Filed: Dec. 3, 2020
(86) PCT No.: PCT/EP2020/084377

§ 371 Date: Jun. 13, 2022

(30) Foreign Application Priority Data
Dec. 13, 2019 (SE) 1951449-6

(51) Int. Cl. A01D 34/00; G05D 1/02

(52) U.S. Cl. CPC A01D 34/008; G05D 1/0214; G05D 1/0276; A01D 2101/00

(57) ABSTRACT

A work tool system (200) comprising a work tool (100) and a server (320), the server (320) comprising a controller (321) and a communication interface (325) and the work tool (100) comprising a controller (110) and a communication interface (115), wherein the server (320) is configured to: receive movement indications for a user (U) through the communication interface (325); determine a movement pattern based on the movement indications; determine a Do Not Disturb area suitable for the movement pattern; and to transmit information on the Do Not Disturb area to the work tool (100) through the communication interface (325); and wherein the work tool (100) is configured to: receive information on the Do Not Disturb area; control the work tool so that the Do Not Disturb area is not violated.

### TECHNICAL FIELD

This application relates to work tools and in particular to a system and a method for performing improved scheduling to be performed for a robotic work tool, such as a lawnmower.

### BACKGROUND

Automated or robotic work tools, such as robotic lawnmowers, are becoming increasingly more common. In a typical deployment, a work area, such as a garden, a park, or a sport's field, is enclosed by a boundary cable (possibly supplemented by one or more beacons, such as Ultra Wide Band beacons, or optical beacons) with the purpose of keeping the robotic work tool inside the work area.

Additionally or alternatively, the robotic work tool may be arranged to navigate using a satellite receiver, such as a GPS (Global Positioning System) receiver.

The robotic work tool is typically arranged to operate within the work area in a random manner or a systematic manner. In both these options, the robotic work tool is basically roaming free in the entire work area and is likely to be in any place at any time during its operation.

For reasons of safety convenience, the work sessions for the robotic work tool are scheduled at times when the work area is uninhabited. For larger work areas, this provides a challenge as the time required to properly service a work area, may exceed the time the work area is uninhabited.

Some known solutions enable for a more efficient scheduling by partitioning the work area into subareas and servicing one subarea at a time. This way, the robotic work tool may service one subarea at a time, leaving most of the work area available for access.

However, as the inventors have realized, persons visiting the work area may not be aware of the partitions and may thus be disturbed by the robotic work tool during its operation.

Thus, there is a need for improved scheduling for a robotic work tool, such as a robotic lawnmower.

### SUMMARY

It is therefore an object of the teachings of this application to overcome or at least reduce those problems by providing a robotic work tool system comprising a robotic work tool and a server, the server comprising a controller and a communication interface and the work tool comprising a controller and a communication interface, wherein the server is configured to: receive movement indications for a user (U) through the communication interface; determine a movement pattern based on the movement indications; determine a Do Not Disturb area suitable for the movement pattern; and to transmit information on the Do Not Disturb area to the work tool through the communication interface; and wherein the work tool is configured to: receive information on the Do Not Disturb area; control the work tool so that the Do Not Disturb area is not violated.

In one embodiment the robotic work tool is a robotic lawnmower.

It is also an object of the teachings of this application to overcome the problems by providing a method for use in a robotic work tool system comprising a robotic work tool and a server, wherein the method comprises in the server: receiving movement indications for a user (U) through the communication interface; determining a movement pattern based on the movement indications; determining a Do Not Disturb area suitable for the movement pattern; and transmitting information on the Do Not Disturb area to the work tool; and wherein the method comprises in the work tool: receiving information on the Do Not Disturb area; and controlling the work tool so that the Do Not Disturb area is not violated.

It is also an object of the teachings of this application to overcome the problems by providing a computer-readable medium comprising computer-readable instructions that when loaded into and executed by a controller enables the controller to execute the method according to herein.

By safeguarding the convenience of the user, a more efficient scheduling of a robotic lawnmower is enabled, as the robotic lawnmower may operate simultaneous with the user inhabiting the work area.

The inventors have further realized that the efficiency of the robotic work tool may further be improved by also tracking other devices that are outside the control of the system. As such devices cannot be controlled by the system, there is a risk of the robotic work tool and the other device colliding or otherwise hindering each other's operation, thus reducing the efficiency of both the robotic work tool and the other device. The teachings herein may thus also be used for non-human users, being outside the control of the system.

Other features and advantages of the disclosed embodiments will appear from the following detailed disclosure, from the attached dependent claims as well as from the drawings. Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention will be described in further detail under reference to the accompanying drawings in which:

FIG. 1A shows an example of a robotic lawnmower according to one embodiment of the teachings herein;

FIG. 1B shows a schematic view of the components of an example of a robotic work tool being a robotic lawnmower according to an example embodiment of the teachings herein;

FIG. 2 shows an example of a robotic work tool system being a robotic lawnmower system according to an example embodiment of the teachings herein;

FIG. 3 shows further components of an example of a robotic work tool system being a robotic lawnmower system according to an example embodiment of the teachings herein;

FIGS. 4A-4H show schematic views of different No-Go areas according to an example embodiment of the teachings herein;

FIGS. 5A and 5B shows a schematic view of an example situation according to an example embodiment of the teachings herein;

FIG. 6A shows a schematic component view of a user position determining device according to an example embodiment of the teachings herein;

FIG. 6B shows a schematic component view of a server according to an example embodiment of the teachings herein;

FIG. 7 shows a schematic view of a computer-readable medium carrying computer instructions according to an example embodiment of the teachings herein;

FIG. 8 shows a corresponding flowchart for a method according to an example embodiment of the teachings herein; and

FIG. 9 shows an example of a work tool system according to an example embodiment of the teachings herein.

### DETAILED DESCRIPTION

The disclosed embodiments will now be described more fully hereinafter with reference to the accompanying drawings, in which certain embodiments of the invention are shown. This invention may, however, be embodied in many different forms and should not be construed as limited to the embodiments set forth herein. Like reference numbers refer to like elements throughout.

It should be noted that even though the description given herein will be focused on robotic lawnmowers, the teachings herein may also be applied to robotic ball collectors, robotic mine sweepers, robotic farming equipment, cleaning (vacuuming/brushing/dusting/sweeping) robots, garbage collecting robots, construction robotic work tools or other robotic work tools operating in close proximity to users or other persons that may be disturbed by the robotic work tool. As discussed below, the robotic work tool may also be an unmanned aerial vehicle.

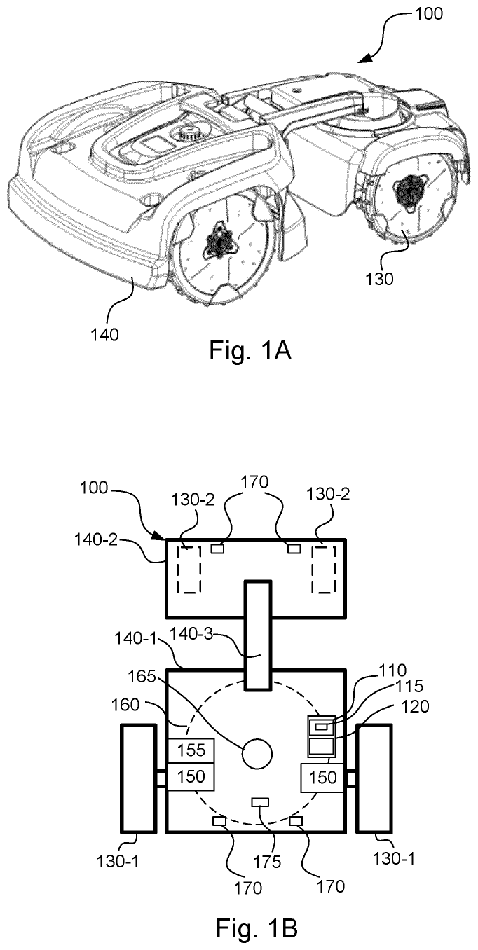

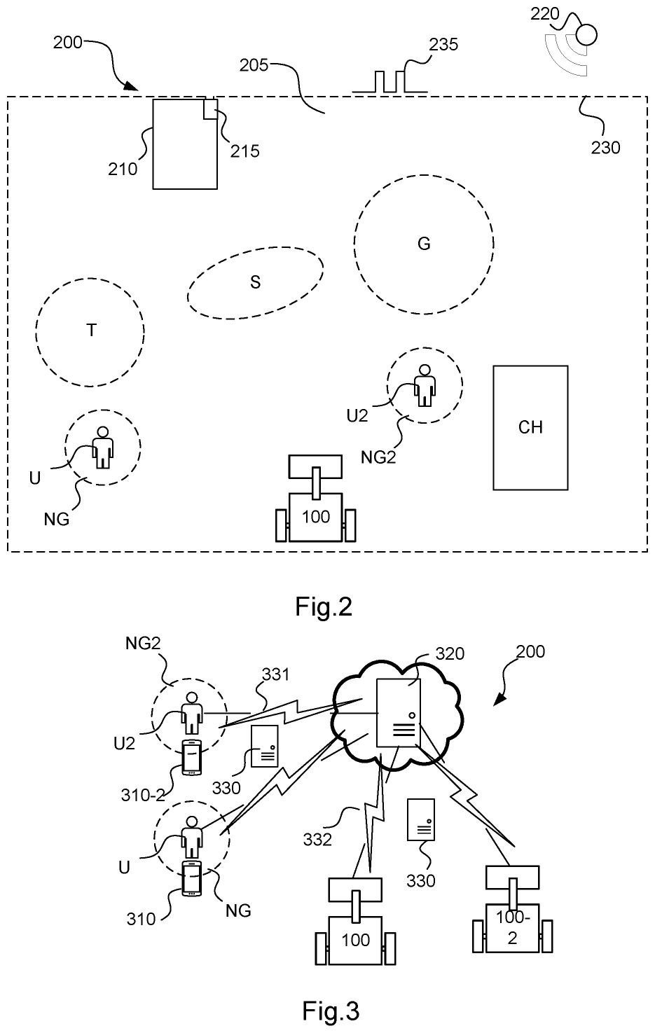

FIG. 1A shows a perspective view of a robotic work tool 100, here exemplified by a robotic lawnmower 100, having a body 140 and a plurality of wheels 130 (only one shown). The robotic lawnmower 100 may comprise charging skids for contacting contact plates (not shown in FIG. 1) when docking into a charging station (not shown in FIG. 1, but referenced 210 in FIG. 2) for receiving a charging current through, and possibly also for transferring information by means of electrical communication between the charging station and the robotic lawnmower 100.

FIG. 1B shows a schematic overview of the robotic work tool 100, also exemplified here by a robotic lawnmower 100. In this example the robotic lawnmower 100 is of an articulated or multi-chassis design, having a main or first body part 140-1 and a trailing or second body part 140-2. The two parts are connected by a joint part 140-3. The robotic lawnmower 100 also has plurality of wheels 130. In the exemplary embodiment of FIG. 1B the robotic lawnmower 100 has four wheels 130. In one embodiment, as shown in FIGS. 1A and 1B, the robotic work tool is arranged with wheels for propelling the robotic work tool. It should be noted though that other means of propulsion are also possible and considered included in this text. In one embodiment, the robotic work tool is arranged with continuous track propulsion. In one embodiment the robotic work tool is arranged for a combined continuous track and wheel propulsion. In one embodiment the robotic work tool is arranged for other forms of propulsion, for example legs, propeller, turbine, magnetic levitation, or screw propulsion.

In one embodiment the robotic work tool is arranged for flying propulsion, the robotic work tool then being an unmanned aerial vehicle arranged with wings and propeller(s) and/or with rotors.

In the example embodiment of FIGS. 1A and 1B, the main body 140-1 is arranged with two front wheels 130-1 and the trailing body 140-2 is arranged with two rear wheels 130-2. At least some of the wheels 130 are drivably connected to at least one electric motor 150. It should be noted that even if the description herein is focused on electric motors, combustion engines may alternatively be used, possibly in combination with an electric motor.

It should be noted that the multi-chassis robotic work tool of FIG. 1B is only one example, and in other example embodiments the robotic lawnmower 100 is of a mono-chassis type, having a main body part 140, that substantially houses all components of the robotic lawnmower 100.

The robotic lawnmower 100 also comprises a grass cutting device 160, such as a rotating blade 160 driven by a cutter motor 165. The grass cutting device being an example of a work tool 160 for a robotic work tool 100. The robotic lawnmower 100 also has (at least) one battery 155 for providing power to the motors 150 and/or the cutter motor 165.

The robotic lawnmower 100 also comprises a controller 110 and a computer readable storage medium or memory 120. The controller 110 may be implemented using instructions that enable hardware functionality, for example, by using executable computer program instructions in a general-purpose or special-purpose processor that may be stored on the memory 120 to be executed by such a processor. The controller 110 is configured to read instructions from the memory 120 and execute these instructions to control the operation of the robotic lawnmower 100 including, but not being limited to, the propulsion of the robotic lawnmower. The controller 110 may be implemented using any suitable, available processor or Programmable Logic Circuit (PLC). The memory 120 may be implemented using any commonly known technology for computer-readable memories such as ROM, RAM, SRAM, DRAM, FLASH, DDR, SDRAM or some other memory technology.

The robotic lawnmower 100 may further be arranged with a wireless communication interface 115 for communicating with other devices, such as a server (not shown in FIG. 1, but referenced 320 in FIG. 3), a smartphone (not shown in FIG. 1, but referenced 310 in FIG. 3), or the charging station. Examples of such wireless communication devices are Bluetooth®, Global System Mobile (GSM) and LTE (Long Term Evolution), to name a few.

For enabling the robotic lawnmower 100 to navigate with reference to a boundary cable emitting a magnetic field caused by a control signal transmitted through the boundary cable, the robotic lawnmower 100 may be further configured to have at least one magnetic field sensor 170 arranged to detect the magnetic field (not shown) and for detecting the boundary cable and/or for receiving (and possibly also sending) information from a signal generator (will be discussed with reference to FIG. 2). In some embodiments, the sensors 170 may be connected to the controller 110, and the controller 110 may be configured to process and evaluate any signals received from the sensors 170. The sensor signals are caused by the magnetic field being generated by the control signal being transmitted through the boundary cable. This enables the controller 110 to determine whether the robotic lawnmower 100 is close to or crossing the boundary cable, or inside or outside an area enclosed by the boundary cable.

It should be noted that the magnetic field sensor(s) 170 as well as the boundary cable (referenced 230 in FIG. 2) and any signal generator(s) (referenced 215 in FIG. 2) are optional. The boundary cable may alternatively be used as the main and only perimeter marker. The boundary cable may alternatively simply be used as an additional safety measure and other navigation sensors (see below) are used for more detailed or advanced operation.

In one embodiment, the robotic lawnmower 100 may further comprise a satellite receiver 175, such as a GPS receiver (Global Positioning System) or other GNSS (Global Navigation Satellite System) receiver.

The robotic work tool may also optionally comprise a beacon receiver which may be a Radio Frequency receiver, such as an Ultra Wide Band (UWB) receiver, configured to receive signals from a Radio Frequency beacon, such as a UWB beacon. The beacon receiver may alternatively be an optical receiver configured to receive signals from an optical beacon.

FIG. 2 shows a schematic view of a robotic work tool system 200 in one embodiment. The schematic view is not to scale. The robotic work tool system 200 comprises a robotic work tool 100 and a charging station 210 which may have a signal generator 215. As with FIGS. 1A and 1B, the robotic work tool 100 is exemplified by a robotic lawnmower, whereby the robotic work tool system is a robotic lawnmower system or a system comprising a combinations of robotic work tools, one being a robotic lawnmower, but the teachings herein may also be applied to other robotic work tools adapted to operate within a work area. Other examples of robotic work tools are watering robots, mulching robots, golf ball collecting robots to mention a few examples.

The robotic work tool system 220 may alternatively (as is noted by the dashed lines) comprise a boundary cable 230 arranged to enclose a work area 205, in which the robotic lawnmower 100 is supposed to serve. In such an embodiment, a control signal 235 is transmitted through the boundary cable 230 causing a magnetic field (not shown) to be emitted.

In one embodiment, the control signal 235 is a sinusoid periodic current signal. In one embodiment the control signal 235 is a pulsed current signal comprising a periodic train of pulses. In one embodiment the control signal 235 is a coded signal, such as a CDMA signal.

Alternatively or additionally, the robotic work tool system 220 may be arranged to navigate the robotic lawnmower 100 based on satellite signal reception, where signals are received from at least one satellite 220.

The work area 205 is in this application exemplified as a golf course, but can also be other work areas as would be understood. The golf course contains a number of features and/or obstacles (O), exemplified herein by a Tee area (T), a sandpit (S) and a green area (G) as well as a house structure, such as a club house (CH). Indicated in FIG. 2 are also two users (U and U2) that roam the golf course.

To enable operation of the robotic lawnmower while a user is in the work area, while providing for the convenience of the user, such as that the user's play is not disturbed by the robotic lawnmower, the robotic lawnmower 100 is configured to assign an area around a user, and stay away from that area. The area is referred herein as a No-Go (NG) area.

The extent of the No-Go area NG is dynamic as opposed to being static as the sub areas of prior art systems. The robotic lawnmower 100 is configured to receive indications of the user's current position and assign the No-Go area NG to the current position of the user. This enables the robotic lawnmower 100 to assign a No-Go area NG that follows the user as the user roams the work area 205, thereby safeguarding the user's convenience.

The user's movement may be tracked by the robotic lawnmower system by the user carrying a positioning device (such as a GPS transmitter). Additionally or alternatively, the user may be visually tracked by surveillance equipment in the work area or carried by the robotic lawnmower.

The inventors have further realized that only monitoring a user's position may not be sufficient to safeguard the user's convenience. For example, a user may change the direction and/or speed of movement resulting in that the user pushing the No-Go area NG on top of the robotic lawnmower, not having time to evade the user. Another example is that the robotic lawnmower may be annoying simply by being seen by the user. A special situation is that the robotic lawnmower may disturb a user by traversing the direction of a user's strike during an ongoing game.

FIG. 3 shows a schematic view of additional components of the robotic work tool system 200 of FIG. 2. The robotic work tool system 200 further comprises a server 320, configured to receive indications on at least one user's movements, process the movement indications and determine a No-Go area NG that suits the user's movement.

In one embodiment, the server 320 may be part of a cloud service. In one embodiment, the server 320 may be part of the robotic work tool 100. In one embodiment, the server 320 may be part of the charging station 210.

As is noted above, a user's movement may be tracked by a user positioning determining device 310 carried by the user. In one embodiment, the user positioning determining device 310 comprises a satellite receiver, such as a GPS or other GNSS receiver and circuitry for transmitting a position determined based on the satellite receiver.

As is also noted above, a user's movement may be tracked by a surveillance system in the work area, being an example of a user positioning determining device 310.

The indications of a user's movement is transmitted to the server 320 through an uplink 331. In one embodiment, the uplink 331 is direct. In one embodiment, the uplink 331 is indirect. In an embodiment where the uplink 331 is indirect, the uplink 331 may be effected through a link server 330. The link server 330 may be configured to receive movement indications from several users and possibly perform some pre-processing before transmitting indications of the user's position to the server 320. The link server 330 may in one embodiment be part of the robotic lawnmower 100. The link server 330 may in one embodiment be part of the charging station 210.

As the server 320 receives indications of the user's movement, the server is configured to determine a No-Go area NG, i.e. the extent and position of a No-Go area NG, based on the received indications.

In one embodiment the indications of a user's movement comprise a current position. In one embodiment the indications of a user's movement comprise a current speed. In one embodiment the indications of a user's movement comprise a current direction.

In one embodiment the server 320 is further configured to determine the No-Go area NG, based on the number of users moving or being in a group, where a group comprises users within close proximity of one another as will be discussed in greater detail below.

In one embodiment the server 320 is further configured to determine the No-Go area NG, based on an identity of the user.

In one embodiment a user's identity is unique, such as through a unique identifier. In the case of the work area being a golf course, the unique identifier may be the user's membership number.

In one embodiment a user's identity is partial, such as through a characteristic. In one example the characteristic may be related to the work area. In the case of the work area being a golf course, the characteristic may be the user's handicap. As the inventors have inventively realized, players with different handicaps, present different movement patterns.

In one embodiment a user's identity is anonymous.

The server is thus configured to determine a movement pattern that matches the user's movement, and possibly future movement based on the received movement indications. The server 320 then determines a suitable No-Go area that prevents the robotic work tool to disturb the user and thus safeguards the convenience of the user. The movement pattern may be determined by matching the movement indications (and possibly the identity of the user) to previously determined movement patterns for finding a suitable match.

The determined No-Go area NG is communicated to the robotic lawnmower 100 through a downlink 332. As for the uplink 331, the downlink may be direct or indirect, possibly going through a link server 330 (which possibly is the same as used for the uplink).

The robotic lawnmower 100 is then configured to stay away from the No-Go area NG of the user U, thereby avoiding to disturb the user U safeguarding the convenience of the user.

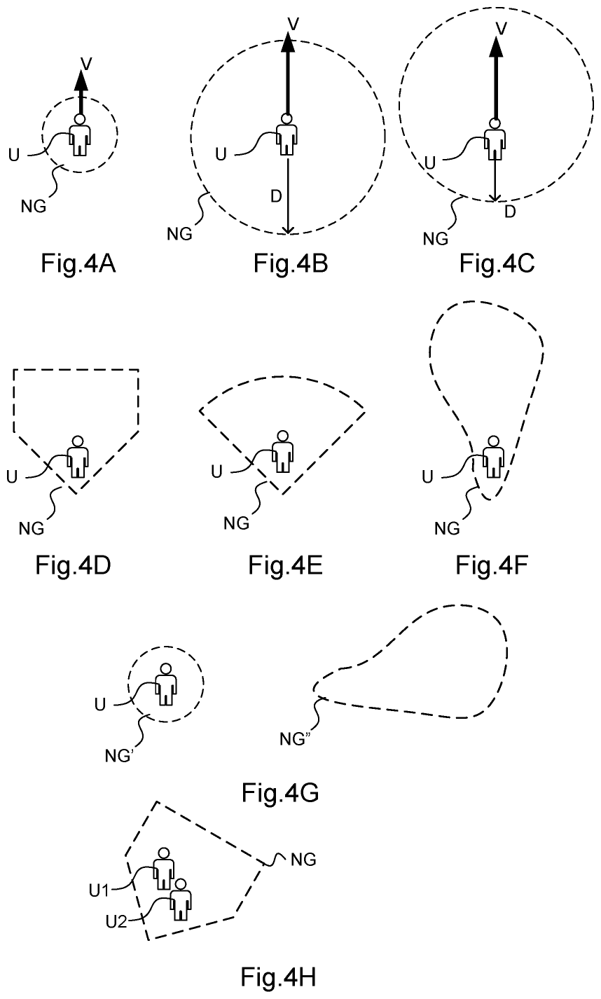

FIGS. 4A-4H shows schematic views of different No-Go areas NG according to the teachings herein. In each figure, a user U is indicated along with a corresponding No-Go area NG. FIGS. 4A and 4B show a situation where the extent of the No-Go area NG is based not only on the position of the user U, but also the speed of the user U. The speed (and direction of speed) is indicated by the vector V in FIGS. 4A and 4B. As can be seen, the speed in FIG. 4B is higher than the speed in FIG. 4A, which is indicated by the vector V being longer in FIG. 4B, than in FIG. 4A. Consequently, the extent of the No-Go area NG is different in FIG. 4B compared to FIG. 4A. In this example, the size of the No-Go area NG is proportional or at least dependent on the speed of the user U, and the No-Go area NG of FIG. 4B is larger than the No-Go area NG of FIG. 4A. This enables for a higher safeguarding of the convenience as a robotic lawnmower 100 will stay further away from a fast moving user U thereby reducing the risk of the robotic lawnmower 100 and the user U crossing paths, thereby further safeguarding the convenience of the user enabling for a more efficient scheduling of a robotic lawnmower, as the robotic lawnmower may operate simultaneous with the user inhabiting the work area.

Furthermore, as the server 320 may be configured to determine a movement pattern and consequently a No-Go area not only based on the location of the user, but possibly also the speed of the user, the No-Go area may also be adapted based on a determined activity of the user. For example, a person running through a park may not follow the same path as a person walking (hand-in-hand) with another user, and the resulting No-Go areas will thus also differ.

FIG. 4C shows a situation where the extent of the No-Go area NG is based not only on the position and speed of the user U, but also the travelling direction of the user U. As in FIGS. 4A and 4B, the travelling direction (and the speed) is indicated by the vector V in FIG. 4C. In this example, the location of the No-Go area NG is dependent on the direction of the user U, and the No-Go area NG of FIG. 4C is located further up in the travelling direction than the No-Go area NG of FIG. 4B. This is indicated by that the distance D (the distance behind the user U) to the edge of the No-Go area NG of FIG. 4C is smaller than the distance D in FIG. 4B. This enables for a higher safeguarding of the convenience as a robotic lawnmower 100 is forced to stay further away from a user U in the direction of travel thereby reducing the risk of the robotic lawnmower 100 and the user U crossing paths and the risk of the robotic lawnmower 100 crossing the field of view of the user U, thereby further safeguarding the convenience of the user enabling for a more efficient scheduling of a robotic lawnmower, as the robotic lawnmower may operate simultaneous with the user inhabiting the work area.

It should be noted that in embodiments where the No-Go area is dependent or proportional to the speed and/or direction of a user, the speed and/or direction of the user may be a current speed and/or direction. The speed and/or direction of the user may alternatively be a determined or predicted speed and/or direction determined as part of the determined movement pattern.

FIGS. 4D and 4E show that the shape of the No-Go area NG need not be circular and simply relying on a radius, but may have other shapes. Common to both shapes of FIGS. 4D and 4E is that the shapes open up in the direction of travel (being larger and offset in that direction), assumingly the direction a user is looking in, thereby reducing the risk that a robotic lawnmower 100 crosses a user's field of view (as will also be the user's direction of play), thereby further safeguarding the convenience of the user enabling for a more efficient scheduling of a robotic lawnmower, as the robotic lawnmower may operate simultaneous with the user inhabiting the work area.

FIGS. 4F and 4G show that the shape of the No-Go area NG need not be regular and continuous, but can also be irregular (No-Go areas NG of FIG. 4F and NG″ of FIG. 4G) and/or discontinuous (No-Go areas NG′ and NG″ of FIG. 4G). A No-Go area is said to be discontinuous if it comprises at least a first and a second sub-area that generally do not overlap one another (should they overlap, they may be considered one and the same sub-area). In the example of FIG. 4G, there are two sub-areas, a first sub-area (NG′) and a second sub-area (NG″), but it should be noted that this is only one example and any number of subareas may be used. As a user moves, the No-Go areas (and sub-areas) may also move and/or change in their extent. One sub-area may then coincide with a second sub-area, upon which they are considered as one and the same sub area. One manner of expressing this is that, the subareas move and/or change independently of one another, and may then overlap, but being distinct sub-areas.

In one embodiment, the server 320 is further configured to receive indications of movement for a user over time and to process the movement indications to identify and determine usual movement patterns for the user. In one such embodiment, the server 320 is further configured to determine No-Go area NG(s) for a second user, based on such usual movement patterns for the first user.

FIG. 4H shows that the No-Go area NG may be determined for more than one user, in this example a first user U1 and a second user U2.

In one embodiment, the server 320 is further configured to receive indications of movement for a plurality of users over time and to process the movement indications to identify and determine common movement patterns. In one such embodiment, the server 320 is further configured to determine No-Go area NG(s) for a user, based on such common movement patterns for the plurality of users.

The server 320 may, as indicated above, determine the No-Go area NG based on an identity (unique, partial and/or anonymous) of the user. The user may thus determine a movement pattern for users that share an identity (i.e. a common movement pattern) and base the No-Go area NG on the common movement pattern.

Based on the determined movement pattern, the No-Go areas NG may be determined so that the No-Go area NG best fits or suits the movement pattern. For example, a movement pattern experiencing a lot of changes in direction, a wide No-Go area NG in all direction is suitable, whereas a movement pattern that constitutes movement in a straight line, an elongated No-Go area NG being offset in the direction of travel is suitable.

In particular, a No-Go area NG may be adapted so that it excludes areas already visited by the user as it is not highly likely in most situations that a user returns to an already visited area, such as behind the user when walking along a path.

For the golf example, the No-Go areas may be adapted so that it allows the robotic lawnmower to enter areas already played by a user, or not yet reached by a user. For situations where several players, or users, are on the golf course, the robotic lawnmowers may be controlled so that they operate behind and in between players, but never in front of the players, thereby safeguarding the convenience of the players enabling a more efficient scheduling of a robotic lawnmower, as the robotic lawnmower may operate simultaneous with the players inhabiting the golf course.

The movement pattern may indicate a feature or location that is usually visited, and the resulting No-Go area NG will then include that feature or location. As has been noted above, the No-Go area NG may also be determined to be dynamic, meaning that the No-Go area NG changes depending on for example the user's movement. For the example of a No-Go area NG that includes a feature, the feature will then be included at least up until the user visits the feature.

Returning to FIG. 4G, the No-Go area NG shown comprises two parts NG′ and NG″. The first No-Go area NG part NG′ may correspond to a tee area (T) and the second No-Go area NG″ may correspond to a greenway or green (G) area. This allows for the user (or player) to not be disturbed both in the tee area (T) as well as not being distracted by the robotic lawnmower 100 entering the greenway area the player, the greenway area being the presumed area which the player will aim for based on the player's identity (for example identity, handicap or membership level).

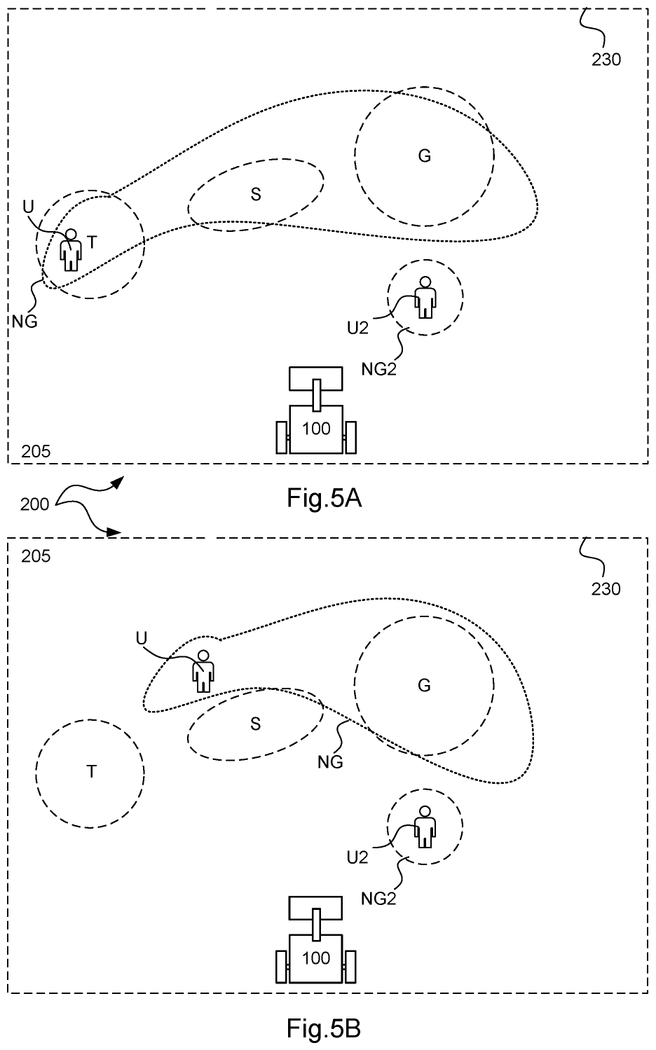

FIGS. 5A and 5B shows a schematic view of the example situation where a user U is being tracked and a No-Go area NG is determined. In this example the No-Go area NG includes parts of a golf course including the tee area (T) where the user starts playing the ball in FIG. 5A. As the user U moves across the golf course, the No-Go area NG adapts dynamically to allow the robotic lawnmower 100 to service areas behind the user, i.e. areas already visited.

As can be seen in FIG. 3, the server 320 may determine No-Go areas NG for more than one robotic work tool 100. The server 320 may be configured to determine the same No-Go areas NG for both a first robotic work tool 100 and a second robotic work tool 100-2. In such an embodiment, the first and the second robotic work tools 100 then stay away from the same areas. Alternatively or additionally, the server 320 may be configured to determine different No-Go areas NG for both a first robotic work tool 100 and a second robotic work tool 100-2. In such an embodiment, the first and the second robotic work tools 100 then stay away from the different areas. The different No-Go areas NG may be different in location and/or in extent.

As can also be seen in FIG. 3 and in FIGS. 5A and 5B, the server 320 may determine No-Go areas NG for more than one user. The server 320 may be configured to determine the same No-Go areas NG for a first user U and a second user U2, if it is determined that the two users are in close proximity to one another, where close proximity means that they are within a specific distance (for example 2, 3, 5, or 10 meters) of one another. For example, a person running through a park may not follow the same path as a person walking (hand-in-hand) with another user. In one such an embodiment, the server may be configured to determine the combined No-Go area NG as the bigger of the two individual No-Go areas NG that would have resulted if the users where not in close proximity to one another. In another such an embodiment, the server may be configured to determine the combined No-Go area NG as the envelope of the two individual No-Go areas NG that would have resulted if the users where not in close proximity to one another.

In one embodiment, the server 320 is configured to determine the No-Go area NG based on a movement pattern that is determined for a group of users, the group comprising at least the first and the second user. To this effect, as the inventors have realized, a user may move in one way when being alone, and in another way when being in the company of another user.

As noted above, the server 320 being arranged to determine movement patterns and consequently No-Go areas, also referable as a movement determining server or a No-Go area server, is, in one embodiment, configured to receive movement indications from a plurality of users. The plurality of users may correspond to a large population of user, possibly associated with different work areas and/or different robotic work tools. For example, a golf course server 320 may be configured to receive movement indications from members not only of one golf club, but from members of many different golf clubs, perhaps even spanning different countries. Similarly, a park server 320 may be configured to receive movement indications from visitors not only of one park, but from visitors to many different parks, perhaps even in different countries.

The amount of data may thus be rather large, especially over time, whereby certain movement patterns may be determined with a high statistical accuracy.

The movement patterns may be determined through the use of various Neural Networks applied to the data representing the movement indications. Other data mining techniques may also be used to determine the movement patterns and consequently the No-Go areas.

The No-Go areas may be determined by gathering or receiving movement indications from a (large) number of users, possibly over time and/or from a plurality of work areas and to generate mathematical models (being reference) based on the gathered data, which mathematical models correspond to user movements. The server is thus determined to perform a (dynamic) simulation of a user's movements based on those mathematical models, attempting to predict a user's future movements by comparing the user's current movements to the reference models and using matching models to predict the user's future or next movements for controlling the application of No-Go areas.

In one embodiment the movement indications also comprise environmental factors, such as temperature, humidity and time of day. As such environmental factors may influence movement patterns significantly, they may increase the accuracy of the determination of movement patterns and consequently the No-Go areas.

In the examples of the detailed description, a user is, in one embodiment, a human, exemplified by a park visitor or a (golf) player. However, as is noted in the summary, a user may also be a moving device (such as a robot or robotic work tool) that is outside the control of the system 200. As the device user is outside the control of the system, there is principally no difference—as the inventors have realized—in tracking its movement and that of a human user's movement. The tracking means may also be used to identify the device user and/or type of device user, possibly through use of visual recognition systems.

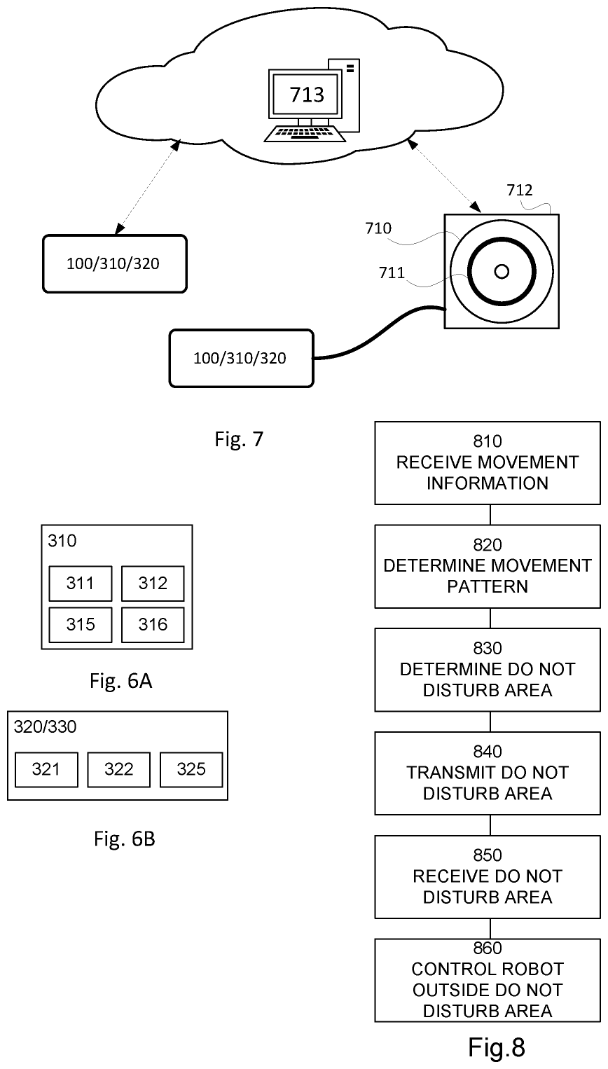

FIG. 6A shows a schematic component view of a user position determining device 310 according to the teachings herein. In one example embodiment, the user position determining device 310 is a smartphone. In such an embodiment, a smartphone may be adapted to perform the invention by downloading and installing a software module from a computer-readable medium comprising computer instructions that when executed by a controller perform the relevant teachings herein.

The user position determining device 310 comprises a controller 311 and a computer readable storage medium or memory 312. The controller 311 may be implemented using instructions that enable hardware functionality, for example, by using executable computer program instructions in a general-purpose or special-purpose processor that may be stored on the memory 312 to be executed by such a processor. The controller 311 is configured to read instructions from the memory 312 and execute these instructions to control the operation of the user position determining device 310 including, but not being limited to, the propulsion of the robotic lawnmower. The controller 311 may be implemented using any suitable, available processor or Programmable Logic Circuit (PLC). The memory 312 may be implemented using any commonly known technology for computer-readable memories such as ROM, RAM, SRAM, DRAM, FLASH, DDR, SDRAM or some other memory technology.

The user position determining device 310 may further be arranged with a wireless communication interface 315 for communicating with other devices, such as the server 320. Examples of such wireless communication devices are Bluetooth®, Global System Mobile (GSM) and LTE (Long Term Evolution), to name a few.

The user position determining device 310 further comprise a device 316 for determining the position of the user.

In one embodiment the device 316 is a surveillance tool such as a camera arranged for tracking the user. In such an embodiment, the user position determining device 310 is mounted in the work area, or on the robotic work tool 100.

In one embodiment the device 316 is a satellite receiver 316, such as a GPS receiver (Global Positioning System) or other GNSS (Global Navigation Satellite System) receiver. In such an embodiment, the user position determining device 310 is carried by the user or at least carried along with the user, such as when the device 316 is arranged in a vehicle or an object belonging to a user. For the example of the work area being a golf course, the user position determining device 310 may be arranged on a golf buggy or in a golf bag.

In an embodiment where the user is a device, the user position determining device 310 may be comprised in the user.

FIG. 6B shows a schematic component view of a server 320/330 according to the teachings herein. In one example embodiment, the server 320/330 is a link server 330. In one example embodiment, the server 320/330 is the No-Go area determining server 320. The server 320/330 may be adapted to perform the invention by downloading and installing a software module from a computer-readable medium comprising computer instructions that when executed by a controller perform the relevant teachings herein.

The server 320/330 comprises a controller 321 and a computer readable storage medium or memory 322. The controller 321 may be implemented using instructions that enable hardware functionality, for example, by using executable computer program instructions in a general-purpose or special-purpose processor that may be stored on the memory 322 to be executed by such a processor. The controller 321 is configured to read instructions from the memory 322 and execute these instructions to control the operation of the server 320/330 including, but not being limited to, the propulsion of the robotic lawnmower. The controller 321 may be implemented using any suitable, available processor or Programmable Logic Circuit (PLC). The memory 322 may be implemented using any commonly known technology for computer-readable memories such as ROM, RAM, SRAM, DRAM, FLASH, DDR, SDRAM or some other memory technology.

The server 320/330 may further be arranged with a wireless communication interface 325 for communicating with other devices, such as the user position determining device 310 and the robotic work tool 100. Examples of such wireless communication devices are Bluetooth®, Global System Mobile (GSM) and LTE (Long Term Evolution), to name a few. For embodiment where the server 325 is part of another device, such as the charging station 210 or the robotic work tool 100, the communication interface may be a wired interface, a memory space, a communication bus, or the communication interface of the device.

FIG. 7 shows a schematic view of a computer-readable medium 710 carrying computer instructions 711 that when loaded into and executed by a controller of device 100/310/320 enables the device 100/310/320 to implement the present invention. In one instance, the device is the robotic lawnmower 100. In one instance, the device is the user positioning determining device 310. In one instance the device is the server 320.

The computer-readable medium 710 may be tangible such as a hard drive or a flash memory, for example a USB memory stick or a cloud server. Alternatively, the computer-readable medium 710 may be intangible such as a signal carrying the computer instructions enabling the computer instructions to be downloaded through a network connection, such as an internet connection.

In the example of FIG. 7, a computer-readable medium 710 is shown as being a computer disc 710 carrying computer-readable computer instructions 711, being inserted in a computer disc reader 712. The computer disc reader 712 may be part of a cloud server 713—or other server—or the computer disc reader may be connected to a cloud server 713—or other server. The cloud server 713 may be part of the internet or at least connected to the internet. The cloud server 713 may alternatively be connected through a proprietary or dedicated connection. In one example embodiment, the computer instructions are stored at a remote server 713 and be downloaded to the memory 102 of the device 100/310/320 for being executed by the controller 101.

The computer disc reader 712 may also or alternatively be connected to (or possibly inserted into) a device 100/310/320 for transferring the computer-readable computer instructions 711 to a controller of the device (presumably via a memory of the device 100/310/320). In one instance, the device is the robotic lawnmower 100. In one instance, the device is the user positioning determining device 310. In one instance the device is the server 320.

FIG. 7 shows both the situation when a device 100/310/320 receives the computer-readable computer instructions 711 via a server connection and the situation when another device 100/310/320 receives the computer-readable computer instructions 711 through a wired interface. This enables for computer-readable computer instructions 711 being downloaded into a device 100/310/320 thereby enabling the device 100/310/320 to operate according to and implement the invention as disclosed herein.

FIG. 8 shows a flowchart of a general method according to the teachings herein. The method is generally for use in a work tool system 200 as discussed herein comprising a work tool, for example being a robotic lawnmower 100, and a server 320. The method comprises the server 320 receiving 810 movement indications for a user (U) for example through the communication interface 325. The server 320 then determines 820 a movement pattern based on the movement indications and determines 830 a Do Not Disturb area suitable for the movement pattern, and transmits 840 information on the Do Not Disturb area to the work tool 100 possibly through the communication interface 325. The method continues in the work tool 100 by the work tool 100 receiving 850 the information on the Do Not Disturb area and controlling 860 the work tool so that the Do Not Disturb area is not violated.

The description herein has been focussed on a robotic work tool system in which (at least) one robotic work tool, exemplified through a robotic lawnmower, is controlled. However, as the inventors have realized, the teachings herein may also be used beneficially for other control systems for work tools such as watering systems, lightning systems, audio systems, manure spreading systems, fan or other air condition systems to mention a few examples. Defining the No-Go areas as areas where a user should not be disturbed, i.e. Do Not Disturb (DND) areas, the system here may be used to control tools in such a manner that a user is not disturbed while traversing an area, such as a work area. The system may also be used to save on power. For example, the watering system of a park may be controlled so that a user does not run any risk of getting wet while walking through a park (for example) by turning of the watering system in the DND areas.

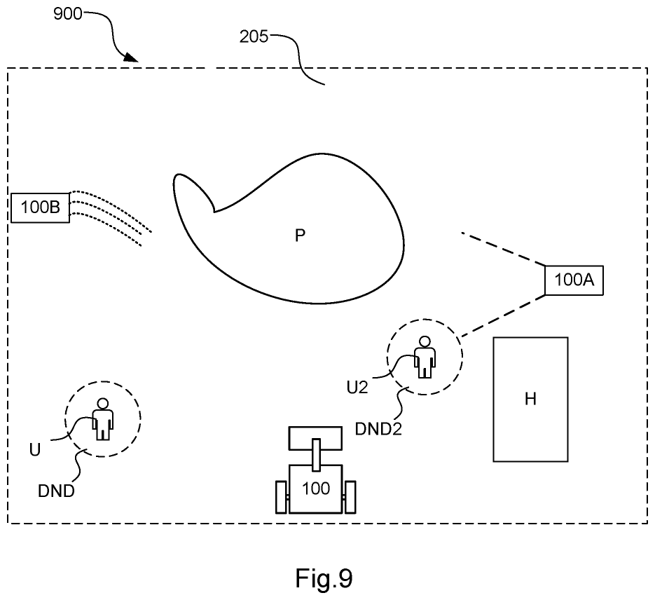

FIG. 9 shows a schematic view of a work tool system 900. The robotic work tool system 200 of FIGS. 2 and 3 are examples of such a work tool system 900. The schematic view is not to scale. The work tool system 900 comprises at least one work tool 100. In the example of FIG. 9, the work tool system comprises a robotic work tool 100, exemplified by a robotic lawnmower as in FIGS. 1A and 1B, a lightning system 100A and a watering system 100B. Other examples of robotic work tools are watering robots, mulching robots, golf ball collecting robots to mention a few examples.

A work area 205 is in this application exemplified as a golf course, but can also be other work areas as would be understood. The golf course contains a number of features and/or obstacles, exemplified herein by a pond (P), and a house structure (H). Indicated in FIG. 9 are also two users (U and U2) that roam the golf course.

To enable for a hassle-free playing experience, a Do Not Disturb area is arranged associated with each user (DND and DND2), the Do Not Disturb areas corresponding to the No Go areas discussed herein.

In one embodiment a work tool, such as a robotic work tool, is allowed to be active in a Do Not Disturb area, but only in a stealth mode. In such an embodiment, the work tool is said to not violate the Do Not Disturb (or No Go area). The work tool is, in such an embodiment, configured to enter at least an active mode and a stealth mode. The active mode is a mode where the work tool is allowed to operate at full capacity, and the stealth mode is a mode where the work tool is arranged to operate at a reduced capacity. The work tool may be arranged to propel at a lower velocity, both the movement and the sound generated by the motors and other drive means being less disturbing. The work tool may also or alternatively be arranged to operate at a lower efficiency, such as by reducing the power supplied to the cutting blades, both the effect of the reduced operation and the sound generated by the work tool being less disturbing. Not violating a Do Not Disturb area can thus either be to not enter the area or to enter it in a stealth mode. Alternatively or additionally, not violating a Do Not Disturb area can thus be to not enter the area and to operate in a stealth mode within a distance (for example 5 or 10 meters) from the Do Not Disturb area.

Returning to the example of FIG. 2 (and of FIG. 9) a specific embodiment relating to a golf course will be discussed. For a work tool system 200 being used for a golf course, such as a robotic work tool system comprising a robotic lawnmower, and possibly also other robotic work tools or work tools, the users are the players moving over the golf course. For simplicity the description herein will only focus on the players, but the users may also include ground keepers and caddies.

The players may be identified explicitly through their memberships of the corresponding golf club. Alternatively the players may be identified partially as members of the corresponding golf club and/or their handicap. As a player signs up for club membership, possible temporary, the player may accept the level of identifying to be used.

The player may also sign up for the robotic work tool system to monitor and track a player over the golf course so that a detailed summary of the session may be provided to the player.

As a player enters the golf course, the monitoring by the system starts and No-Go areas are determined and deployed as appropriate during the game play, thus preventing a user to be delayed by work tools disturbing the player prolonging the player's game unnecessarily, thereby also improving the scheduling of the robotic work tool.

In one embodiment, the system may be configured to determine that a No-Go area of a first player will overlap or coincide with a No-Go area of a second player (not belonging to a group of the first player). Alternatively, the system may be configured that the determined path (or movement pattern) of a first player will cross or coincide with a determined path of a second player. In such instances, the system is configured to alert the player that the movement patterns will overlap, i.e. that a queue for a hole may be formed, advising the player to possible halt, delay or play an alternative hole so as to avoid wasting time, thereby also improving the scheduling of the robotic work tool.

In one embodiment, the robotic work tool 100 may be controlled to remove the flag as it is determined that a player will enter the green, such as when a player has played the ball onto the green and is now travelling towards the green. Similarly the robotic work toll may be configured to return the flag as a player leaves the green.

1. A work tool system comprising a work tool and a server, the server comprising a controller and a communication interface and the work tool comprising a controller and a communication interface, wherein
the server is configured to:
receive movement indications for a user through the communication interface;
determine a movement pattern based on the movement indications;
determine a Do Not Disturb area suitable for the movement pattern; and to
transmit information on the Do Not Disturb area to the work tool through the communication interface; and wherein
the work tool is configured to:
receive information on the Do Not Disturb area;
control the work tool so that the Do Not Disturb area is not violated.

2. The work tool system according to claim 1, wherein the Do Not Disturb area is dynamic and adapts to the movements of the user.

3. The work tool system according to claim 1, wherein the server is further configured to determine the Do Not Disturb area based on the speed of the user.

4. The work tool system according to claim 1, wherein the server is further configured to determine the Do Not Disturb area based on the direction of travel of the user.

5. The work tool system according to claim 1, wherein the server is further configured to determine the Do Not Disturb area based on the identity of the user.

6. The work tool system according to claim 1, wherein the server is further configured to receive movement indications for a plurality of users, determine at least one common movement pattern based on the received movement indications for the plurality of users and to match the received movement indications for the user to the at least one common movement pattern.

7. The work tool system according to claim 1, wherein the server is further configured to receive several movement indications for the user, determine at least one usual movement pattern based on the received movement indications for the plurality of users and to match the received movement indications for the user to the at least one usual movement pattern.

8. The work tool system according to claim 1, wherein the Do Not Disturb area comprises a first sub-area and a second sub-area.

9. The work tool system according to claim 1, wherein the server is further configured to
receive movement indications for a second user and to determine a Do Not Disturb area based on the movement indications for the user and the movement indications for the second user.

10. The work tool system according to claim 1, wherein the work tool is a watering tool.

11. The work tool system according to claim 1, wherein the work tool is a lighting tool.

12. The work tool system according to any preceding claim 1, wherein the work tool is a fan tool.

13. The work tool system according to claim 1, wherein the work tool system is a robotic work tool system and the work tool is a robotic work tool.

14. The robotic work tool system according to claim 13, wherein the robotic work tool is configured to
control the robotic work tool so that the Do Not Disturb area is not violated, by controlling the navigation of the robotic work tool so that the Do Not Disturb area is not entered.

15. The robotic work tool system according to claim 13, wherein the robotic work tool is configured to
control the robotic work tool so that the Do Not Disturb area is not violated, by controlling the robotic work tool so that the Do Not Disturb area is entered in a stealth mode.

16. The robotic work tool system according to claim 13, wherein the robotic work tool is a robotic lawnmower.

17. The work tool system according to claim 1, wherein the user is human.

18. The work tool system according to claim 1, wherein the user is a non-human outside the control of the work tool system.

19. A method for use in a work tool system comprising a work tool and a server, wherein the method comprises in the server:
receiving movement indications for a user;
determining a movement pattern based on the movement indications;
determining a Do Not Disturb area suitable for the movement pattern; and
transmitting information on the Do Not Disturb area to the work tool; and wherein the method comprises in the work tool:
receiving information on the Do Not Disturb area; and
controlling the work tool so that the Do Not Disturb area is not violated.

20. A computer-readable medium comprising computer-readable instructions that when loaded into and executed by a controller enables the controller to execute the method according to claim 19.
